(19) United States
(12) Patent Application Publication
(10) Pub. No.: US 2007/0132153 A1
(43) Pub. Date: Jun. 14, 2007

(54) Ceramic arc tubes with reduced surface scatter and related methods

(76) Inventors: Hemantkumar Narsinham Aiyer, Bangalore (IN); Balasubramaniam Vaidhyanathan, Bangalore (IN); Sheela Kollali Ramasesha, Bangalore (IN); Bukkinakere Kapanipathaiya Chandrasekhar, Bangalore (IN); Preethi Nayak, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/302,545

(22) Filed: Dec. 13, 2005

(51) Int. Cl. B28B 17/00

(52) U.S. Cl. 264/430; 264/442; 264/162

(57) ABSTRACT

A method for polishing of a ceramic arc tube for use in a HID lamp in order to decrease surface scatter and increase in-line transmission of light through the arc tube. In accordance with one embodiment of the invention, processes are described by which both the inner surface and outer surface of a ceramic arc tube may be polished concurrently. In one embodiment, the ceramic arc tube may be immersed in an abrasive slurry and impacted with the abrasive slurry through generation of a turbulence in the abrasive slurry, for example. In one embodiment, the turbulence may be generated by ultrasonic cavitation within the slurry or by a magnetically induced rotational flow within the slurry.

### BACKGROUND

The present invention relates generally to the field of high intensity discharge lighting.

High Intensity Discharge (HID) lamps produce light by striking an electrical arc across electrodes housed within a specially designed envelope or arc tube filled with a mix of gas and metals. The gas aids in initiating discharge within HID lamps and the metals produce the light once heated to a point of evaporation through the initial discharge. HID lamps include mercury vapor, metal halide, and high-pressure sodium lamps as well as xenon short-arc lamps.

Compared to fluorescent and incandescent lamps, HID lamps produce a large quantity of light in a very small package. Consequently, the arc tubes must be designed to withstand extreme operating temperatures, while maintaining good optical performance.

In certain HID lighting applications, such as automotive and video projection, it is desirable for the HID lamp to generate unscattered light. Typically in such high performance lighting applications, light generated by the arc in the arc tube is reflected and collimated by a reflector. Any scatter of the light from the arc tube can lead to poor optical performance of the lamp. Typically, HID arc tubes are designed in complex, non-planar shapes and are formed from fused quartz. Because quartz is amorphous, it is smooth on a micron to sub-micron length scale and has very small amounts of bulk scatter typically caused by grain boundaries, second phase inclusions, or birefringence. As such, it has traditionally been used as the envelope material of choice in automotive and projection HID lamps.

However, as improvements in HID lamp efficiency and lumen output are made, the mix of discharge gas and metals dosed within the arc tubes continues to change. In particular, it has been found that certain materials used in a mercury-free HID dose can be reactive to quartz. As such, refractory ceramic HID envelopes manufactured from polycrystalline materials are being studied to replace quartz envelopes.

Unfortunately, such polycrystalline materials are not as transparent as quartz leading to diminished in-line light transmission of the arc tube. More specifically, for a polycrystalline material to be converted to a transparent ceramic for use as an HID envelope material, the polycrystalline material must undergo a high-temperature sintering treatment. Although this sintering step can remove internal pores and reduce internal bulk scatter of the material, the high temperature treatment also leaves grain boundary etching in the form of sub-micron to micron sized ridges. These ridges in turn act to reduce the in-line transmission of light from the arc tube through surface scatter of the light.

### BRIEF DESCRIPTION

Methods for polishing a ceramic arc tube for use in a HID lamp in order to decrease surface scatter and increase in-line transmission of light through the arc tube are described. In accordance with one embodiment of the invention, processes are described by which both the inner and outer surfaces of a ceramic arc tube may be polished concurrently. In one embodiment, the ceramic arc tube may be immersed in an abrasive slurry and impacted with abrasive particles through generation of a turbulence in the abrasive slurry, for example. In one embodiment, the turbulence may be generated by ultrasonic cavitation within the slurry or by a magnetically induced rotational flow within the slurry.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of an exemplary high intensity discharge lamp in accordance with aspects of the present invention;

FIG. 2 includes two plots illustrating an expansion of an exemplary ceramic arc tube design space as a result of arc tube surface polishing, in accordance with one embodiment;

FIG. 3 illustrates an example method for polishing ceramic arc tubes in accordance with one embodiment of the invention;

FIG. 4 illustrates an embodiment of an ultrasonic polishing configuration for polishing ceramic arc tubes;

FIG. 5 illustrates an embodiment of a magnetically induced flow configuration for polishing ceramic arc tubes;

FIG. 6 illustrates a graphical representation of how a surface roughness profile of an example sample may appear;

FIG. 7 is a perspective view of a video projection system having a ceramic arc tube 15 in accordance with certain embodiments of the present invention; and

FIG. 8 is perspective view of a vehicle, such as an automobile, having a ceramic arc tube 15 in accordance with certain embodiments of the present invention.

### DETAILED DESCRIPTION

In the following detailed description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Furthermore, various operations may be described as multiple discrete steps performed in a manner that is helpful for understanding embodiments of the present invention. However, the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as well as their inflected forms as used in the present application, are intended to be synonymous unless otherwise indicated.

As will be described in more detail below, aspects of the present invention include polishing of a ceramic arc tube for use in a HID lamp in order to decrease surface scatter and increase in-line transmission of light through the arc tube. In accordance with one embodiment of the invention, processes are described by which both the inner and outer surfaces of a ceramic arc tube may be polished concurrently, thereby reducing process complexity and saving processing time and cost. In one embodiment, the ceramic arc tube may be immersed in an abrasive slurry and impacted with abrasive particles through generation of a turbulence in the abrasive slurry, for example. In one embodiment, the turbulence may be generated by ultrasonic cavitation within the slurry or by a magnetically induced rotational flow within the slurry.

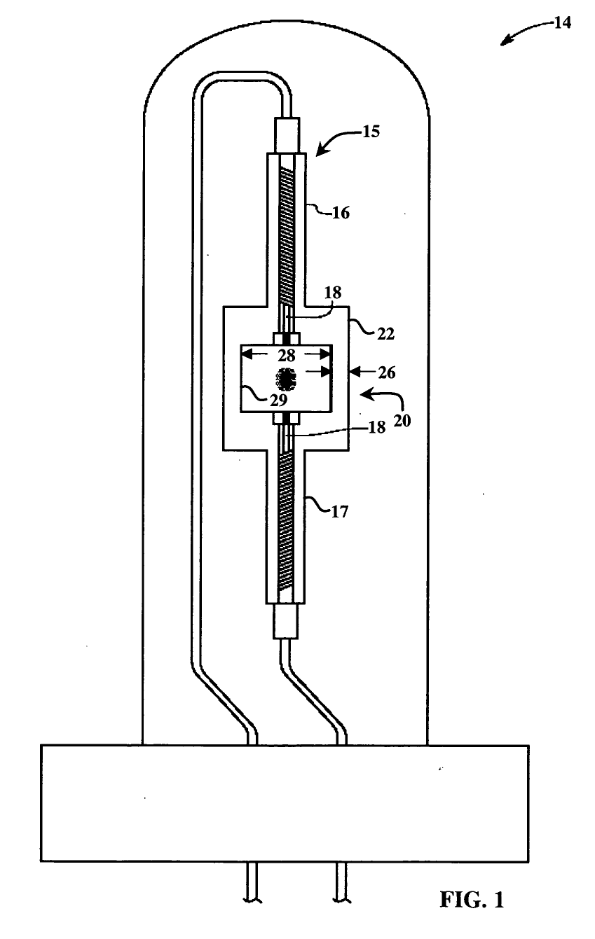

Referring now to the Figures where reference is first made to FIG. 1. FIG. 1 diagrammatically represents a cross-sectional view of an HID lamp 14 including a ceramic arc tube 15. The ceramic arc tube 15 further includes a pair of electrodes 18 disposed at opposing ends of the arc tube 15. When the HID lamp is powered ON, indicating a flow of current to the lamp, a voltage difference is produced across the two electrodes 18. This voltage difference causes a plasma discharge arc to be generated between the electrodes 18.

The ceramic arc tube 15 includes a complex shaped (e.g., non-planar) light transmissive envelope having a body section 20 and shaped leg sections 16, 17 with the body section having a different diameter than the leg sections. The envelope of the ceramic arc tube 15 envelope further includes an inner surface 29 and an outer surface 22 and may be shaped from a single monolithic material or assembled from separately shaped sections. For example, the ceramic arc tube 15 may be assembled from separate leg sections (16, 17) and body sections (20), which may be sintered together to form the envelope of the ceramic arc tube 15. Similarly, the envelope of the ceramic arc tube 15 may be formed from a single crystal, a polycrystalline ceramic, or a combination of single crystal and polycrystalline ceramics. In one embodiment of the invention, the envelope of the ceramic arc tube 15 may be formed from one or more ceramic materials including but not limited to polycrystalline alumina (e.g., Al₂O₃), yttrium aluminum garnet or YAG (e.g., Y₃Al₅O₁₂), Y₂O₃, AlON, Mg₂Al₂O₄, and Lu₂O₃. For the purpose of this disclosure, the term ‘ceramic’ is intended to mean a solid compound formed through the application of heat or heat and pressure between two or more elements where at least one is non-metal.

Because polycrystalline ceramic arc tubes typically undergo a high-temperature sintering treatment during the formation process, they are often left with grain boundary etching in the form of sub-micron to micron-sized ridges. These ridges act to reduce the in-line transmission of light from the arc tube through surface scatter of the light. In accordance with one aspect of the invention, it has been advantageously recognized that by polishing the surfaces of an arc tube 15, the surface roughness of the arc tube can be reduced and in-line transmission of light correspondingly increased.

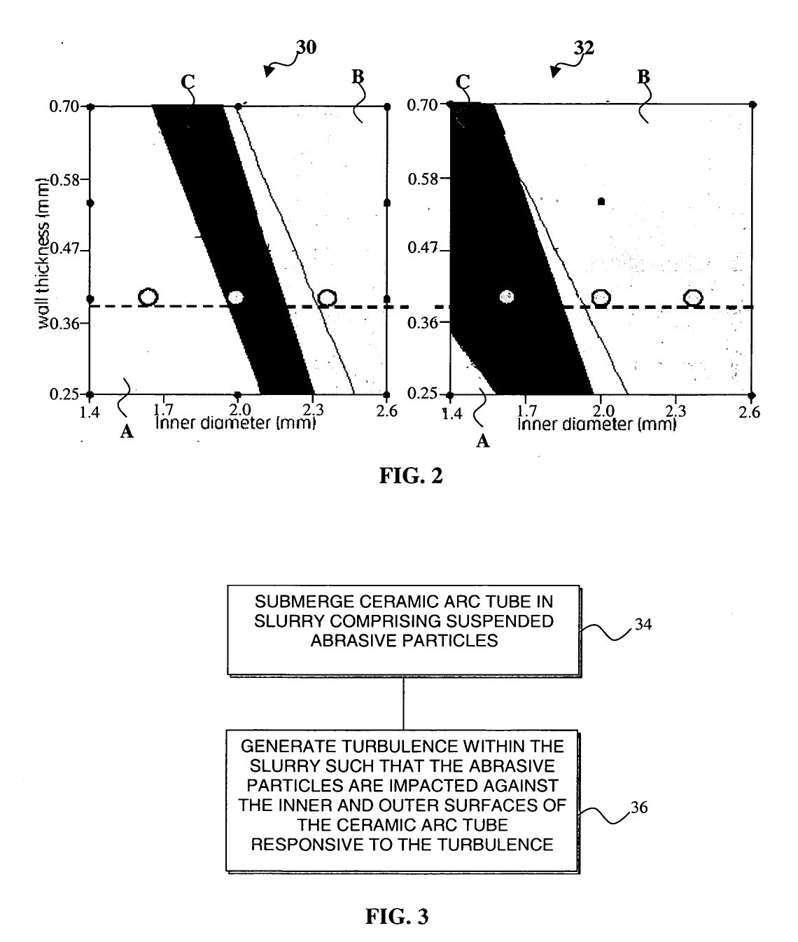

FIG. 2 includes two plots illustrating an expansion of an exemplary ceramic arc tube design space as a result of arc tube polishing, in accordance with one embodiment. More specifically, FIG. 2 illustrates two plots (30, 32) of arc tube envelope wall thickness (indicated by reference number 26 in FIG. 1) versus arc tube envelope inner diameter (indicated by reference number 28 in FIG. 1). The first plot 30 relates to optical polycrystalline alumina (optical PCA), whereas the second plot 32 relates to standard polycrystalline alumina (PCA). Standard PCA may be characterized as having a smaller grain size than that of optical PCA. For example, the grain size of standard PCA may have a grain size of about 25 μm, whereas the grain size of optical PCA may have a grain size of about 50 μm. In both the optical PCA plot 30 and the standard PCA plot 32 the wall thickness values range from about 0.25 mm to about 0.70 mm, while the inner diameter values range from about 1.4 mm to about 2.6 mm. It should be noted that these ceramic arc tube dimensional ranges were selected for plotting based upon the thermal stress models for the same arc tube. More specifically, due to the extreme temperature and optical performance requirements demanded of HID ceramic arc tubes, there is only a finite set of envelope dimensions that will result in acceptable lamp performance. These dimensions are referred to as the lamp design space for a given lamp and are illustrated in plots 30 and 32.

With reference once again to FIG. 2, both the optical PCA plot 30 and the standard PCA plot 32 are separated into three areas. Area ‘A’ represents the allowable design space for a given unpolished ceramic arc tube, whereas area ‘B’ represents dimensions that fall outside of the acceptable design space. Lastly, area ‘C’ represents the increase in allowable design space due to polishing of the ceramic arc tube, which in turn causes a reduction in surface scatter. In optical PCA plot 30 for example, the pre-polish design space (Area A) is relatively large as compared to the pre-polish design space (Area A) of the standard PCA plot 32. This may be at least partly attributed to the larger grain size found in the optical PCA. Nonetheless, it can readily be seen with reference to optical PCA plot 30, that the allowable design space for a given ceramic arc tube can be increased through polishing. However, what is more striking is the increase in design space afforded to the standard PCA as a result of arc tube polishing. More specifically, standard PCA plot 32 illustrates that through polishing of the ceramic arc tube, the allowable inner diameter can be increased by about 0.4 mm while the allowable wall thickness can be increased by about 0.35 mm.

Although the benefits of arc tube polishing have been shown, the amount of effort required to polish a given ceramic arc tube may depend upon the complexity of the arc tube geometry and the process used to create the arc tube. For example, some processes for making an arc tube would require such a significant amount of polishing to achieve a desired in-line transmission that the desired arc tube shape would have to be compromised in order to provide the ability to subsequently polish the arc tube. One method with which to polish a ceramic arc tube could be to assemble the arc tube from simple shapes (e.g. leg and body portions) after the shapes have been individually polished. However, this results in a less optimal arc tube shape design and can lead to weaker arc tubes since e.g., the assembly must be performed after sintering and polishing.

In accordance with one aspect of the present invention, a method is disclosed for polishing concurrently an inner and an outer surface of a ceramic arc tube in order to decrease surface scatter and increase in-line light transmission through the ceramic arc tube. FIG. 3 illustrates an example method for polishing ceramic arc tubes in accordance with one embodiment of the invention. With reference to FIG. 3, the method may begin at block 34 where a ceramic arc tube is immersed in a slurry comprising suspended abrasive particles. As used herein, the term ‘immerse’ or ‘immersed’ refers to the act of surrounding or covering an item such as a ceramic arc tube by a polishing medium such as the abrasive slurry. It is anticipated that the polishing medium may cover all surfaces of the arc tube(s) to be polished, however this is not necessarily required. Furthermore, the terms ‘immersed’, “submerse” and ‘submerged’ as well as their inflected forms may be used interchangeably herein unless otherwise specified.

At block 36, a turbulence is generated within the slurry such that the abrasive particles are impacted against the inner and outer surfaces of the ceramic arc tube responsive to the turbulence. In accordance with one or more embodiments of the invention, the abrasive particles may be impacted concurrently against the inner and outer surfaces of the ceramic arc tube responsive to the generated turbulence. As used herein, the term turbulence or turbulent flow is intended to refer to condition characterized by semi-random, stochastic property changes within the slurry. In accordance with one embodiment of the invention, the turbulence may result from the generation of ultrasonic cavitation within the slurry such that the abrasive particles are impacted against the inner and outer surfaces of the ceramic arc tube concurrently. In accordance with an alternative embodiment, the slurry may comprise magnetic particles in addition to the abrasive particles. Accordingly, in one embodiment the turbulence may result from a magnetically induced rotational flow within the slurry such that the abrasive particles are impacted against the inner and outer surfaces of the ceramic arc tube concurrently.

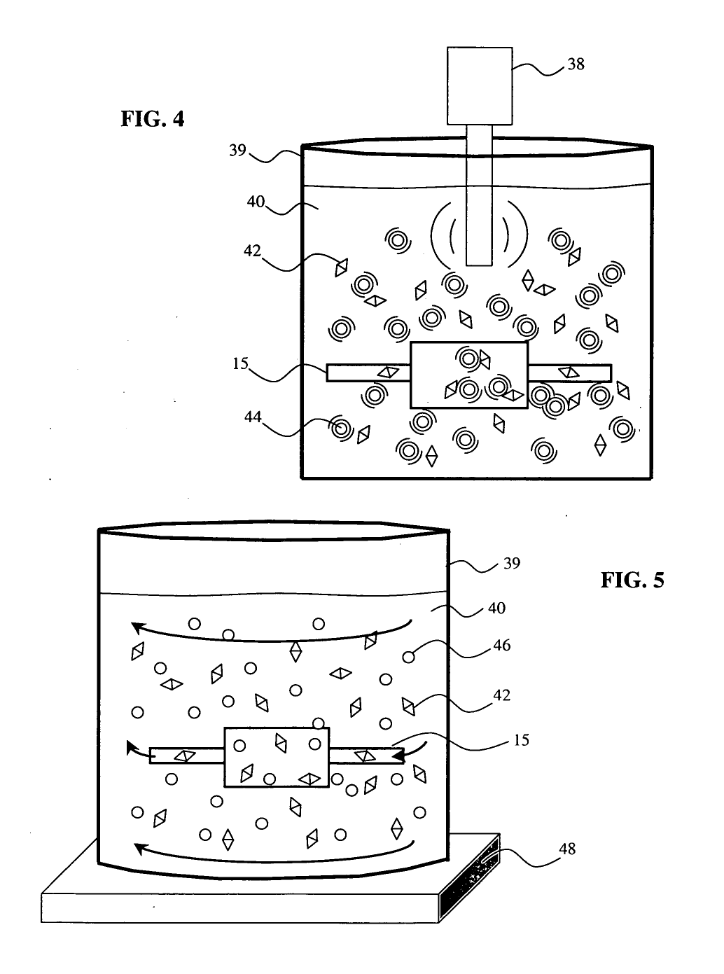

FIGS. 4 and 5 illustrate alternative embodiments for polishing ceramic arc tubes. FIG. 4 illustrates an ultrasonic polishing embodiment for polishing ceramic arc tubes, whereas FIG. 5 illustrates a magnetically induced flow configuration for polishing ceramic arc tubes. With reference to FIG. 4, the illustrated ultrasonic polishing configuration includes a vessel 39 containing an abrasive slurry 40 for polishing, a ceramic arc tube 15 immersed within the abrasive slurry 40, and a ultrasonic generator 38 to generate controlled turbulence through ultrasonic cavitation within the abrasive slurry 40. It should be noted that although in FIG. 4 and FIG. 5 only a single arc tube 15 (see e.g., FIG. 1.) is illustrated, the polishing methodologies described herein are extensible to polish numerous such arc tubes simultaneously. In fact, one advantage of the described methodologies is that they can be easily scaled to a high-volume implementation without a large capital outlay. In contrast, other polishing methodologies require significant amounts of manual intervention and large capital equipment investments.

The ultrasonic generator 38 operates to convert electrical energy to sound waves with ultrasonic frequencies. For example, ultrasonic generator 38 may generate ultrasonic sound waves having frequencies between 18 Kilohertz (KHz) and 100,000 KHz, however frequencies above 100,000 KHz are further possible. In one embodiment, the ultrasonic generator 38 may include an ultrasonic horn or sonotrode that can be immersed within the abrasive slurry 40 as shown. Alternatively, the abrasive slurry may be contained (with or without vessel 39) by the ultrasonic generator in the form of a bath.

As was previously mentioned, the abrasive slurry 40 includes abrasive particles that can be impacted concurrently against both inner and outer surfaces of the arc tube 45. Although a variety of abrasive slurries could be used to polish the ceramic arc tube 15, it has been found that a slurry chemistry that allows the abrasive particles 42 to remain suspended within the slurry during the polishing process results in better polishing performance. In one embodiment, the abrasive slurry 40 may be an aqueous based solution that includes abrasive diamond particles. The abrasive slurry composition may include the diamond particles as the abrasive agent exclusively, or the diamond particles may be combined with other abrasive particles or agents of differing materials. In one embodiment, the diamond particles may range in size from about 0.1 μm to about 20 μm. The composition of the abrasive slurry 40 may include substantially mono- or single-sized abrasive particles, or the composition may include a mix of differently sized particles. Moreover, the ceramic arc tube 15 may be polished using a single slurry, or the ceramic arc tube 15 may be polished in stages with each of the stages utilizing a different slurry composition. Furthermore, in one embodiment, a dispersant such as ammonium salt of polymethacrylic acid (e.g., available under the trade name DARVAN C) may be added to the abrasive slurry composition to reduce potential agglomeration between the abrasive particles. The amount of dispersant added can vary depending e.g., upon the zeta potential of the slurry and the total volume of the abrasive slurry, the abrasive particle size, and the pH of the abrasive slurry.

As the ultrasonic generator 38 operates the abrasive slurry 40 is alternately compressed and rarefied in the production of ultrasonic sound waves. The magnitude of the negative pressure in the areas of rarefaction eventually becomes sufficient to cause the abrasive slurry 40 to fracture, causing cavitation. Cavitation “bubbles” 44 are created at sites of rarefaction as the abrasive slurry 40 fractures or tears because of the negative pressure of the sound wave in the slurry. As the wave fronts pass, the cavitation “bubbles” 44 oscillate under the influence of positive pressure, eventually growing to an unstable size. Finally, the violent collapse of the cavitation “bubbles” results in implosions, which cause shock waves to be radiated from the sites of the collapse. In turn, the collapse and implosion of the cavitation “bubbles” throughout the abrasive slurry 40 causes the abrasive particles 42 to be impacted against the inner and outer surfaces of the arc tube 45.

FIG. 5 illustrates a magnetically induced flow configuration for polishing ceramic arc tubes. The illustrated configuration includes a vessel 39, containing an abrasive slurry 41 that has been enhanced through the addition of magnetic particles 46 and a ceramic arc tube 15 immersed within the abrasive slurry 41. The illustrated configuration further includes a magnetic stirrer plate 48 to induce a force on the magnetic particles to generate a controlled turbulence or turbulent flow within the abrasive slurry 41. Due to the resulting turbulence generated by the magnetic stirrer and the abrasive slurry characteristics, including the size of the magnetic particles 46 and abrasive particles 42, the slurry can freely move around and through the ceramic arc tube 45 thereby concurrently impacting both the inner and outer surfaces of the arc tube. In one embodiment, the abrasive particles may be diamond particles having a particle size of about 0.1 μm to about 20 μm. In one embodiment the magnetic particles 46 may be zinc nickel ferrite particles. Moreover, the magnetic particles 46 may comprise any group of magnetic metals, alloys, oxides, garnets, spinels, ferrites, perovskites, etc.

As was described in connection with the ultrasonic polishing example, the ceramic arc tube 15 in FIG. 5, may be polished using a single slurry, or the ceramic arc tube 15 may be polished in stages with each of the stages utilizing a different. slurry composition. The composition of the magnetically enhanced abrasive slurry 41 may include substantially mono- or single-sized abrasive and/or magnetic particles, or the composition may include a mix of differently sized particles. Furthermore, in one embodiment, a dispersant such as DARVAN C may be added to the abrasive slurry composition 41 to reduce potential agglomeration between the abrasive and/or magnetic particles. The amount of dispersant to be added can vary depending e.g., upon the zeta potential of the slurry as well as the total volume of the abrasive slurry, the abrasive and/or magnetic particle size, and the pH of the abrasive slurry.

In either of the ultrasonic and magnetically induced polishing embodiments described above, the polishing effectiveness can depend upon a number of factors. These factors may include the abrasive particle size or sizes used, the treatment time, and the power of the ultrasonic generator or magnetic stirrer plate. For example, the viscosity of the abrasive slurry composition may contribute to the polishing effectiveness. In one embodiment, an abrasive slurry viscosity between about 0.5 and about 5 centipoises may be desirable.

In one example, a slurry composition comprising 11 μm diamond particles and about 800 microliters of dispersant were used to generate a shear rate of about 60 rpm's within the holding vessel. This resulted in a viscosity of about 2.36 centipoises as measured at room temperature.

In another example, a slurry composition comprising 1 μm diamond particles and about 800 microliters of dispersant were used to generate a shear rate of about 60 rpm's within the holding vessel. This resulted in a viscosity of about 3.2 centipoises as measured at room temperature.

The power of the ultrasonic generator or magnetic stirrer plate may also contribute to the polishing effectiveness. For example, as a general proposition, the more powerful the ultrasonic generator or magnetic stirrer plate is, the faster the polishing may occur, which in turn may decrease the treatment time needed to obtain the same surface roughness.

Surface roughness may be characterized through calculation of the average roughness or ‘Ra’ value. The average roughness is the area between the roughness profile and its mean line, or the integral of the absolute value of the roughness profile height over the evaluation length, where

$${R}_{a} = \frac{1}{L} {\int }_{0}^{L} \vert r ( x ) \vert ⅆ x$$

When evaluated from digital data, the integral may be approximated by a trapezoidal rule:

$${R}_{a} = \frac{1}{N} {\sum }_{n = 1}^{N} \vert {r}_{n} \vert$$

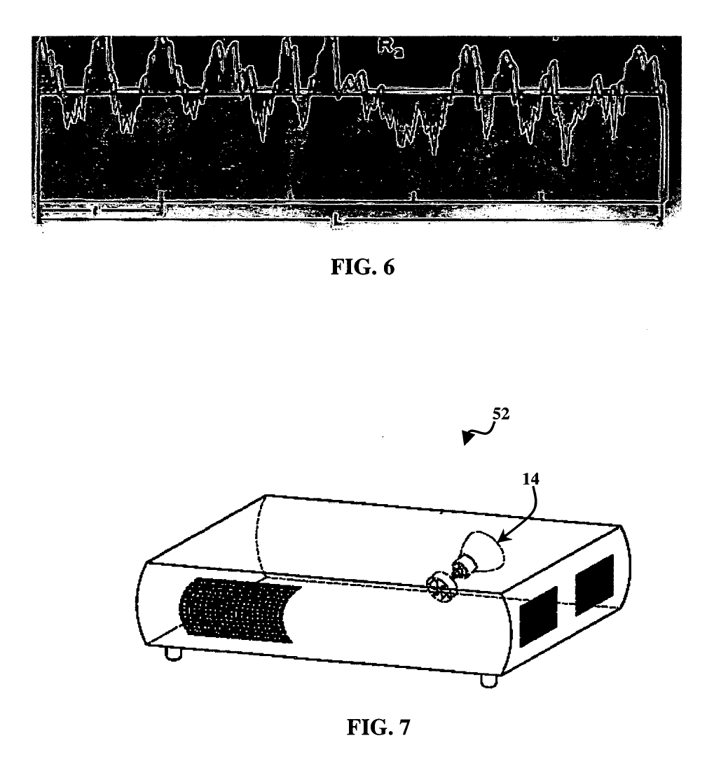

FIG. 6 illustrates a graphical representation of how an example surface roughness profile may appear. With reference to FIG. 6, the average roughness (Ra) can be characterized as the integral of the absolute value of the roughness profile. That is, the shaded area for example, divided by the evaluation length L. In accordance with one embodiment of the invention, the ceramic arc tube 15 may be polished using the ultrasonic or magnetically induced polishing methods described above such that a surface roughness of Ra<100 or preferably Ra<50 is achieved.

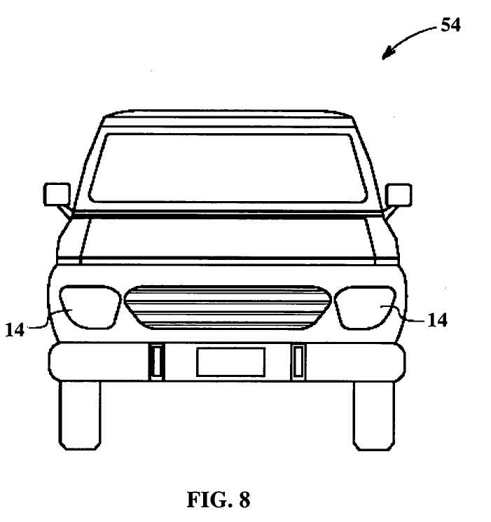

In certain embodiments, the ceramic arc tube 15 illustrated in FIG. 1 may be incorporated or adapted to a variety of applications, such as transportation systems, video systems, outdoor lighting systems, and so forth. For example, FIG. 7 illustrates an embodiment of a video projection system 52 comprising the HID lamp 14 with the ceramic arc tube 15. By further example, FIG. 8 illustrates a vehicle 54, such as an automobile, having a pair of the HID lamps 14 including the ceramic arc tube 15 in accordance with certain embodiments of the present invention.

While only certain features of the invention have been illustrated and described herein, many modifications and changes will occur to those skilled in the art. It is, therefore, to be understood that the appended claims are intended to cover all such modifications and changes as fall within the true spirit of the invention. What is claimed is:

1. A method comprising:
polishing concurrently an inner surface and an outer surface of a ceramic arc tube to decrease surface scatter of the arc tube and increase in-line light transmission through the ceramic arc tube.

2. The method of claim 1, wherein the ceramic arc tube is a non-planar ceramic arc tube.

3. The method of claim 2, wherein the non-planar ceramic arc tube comprises an Ra surface roughness of less than 100.

4. The method of claim 2, wherein the non-planar ceramic arc tube comprises an Ra surface roughness of less than 50.

5. The method of claim 1, wherein polishing further comprises:
immersing the ceramic arc tube in an abrasive slurry; and
impacting the ceramic arc tube with particles suspended in the abrasive slurry.

6. The method of claim 5, further comprising generating a turbulence within the abrasive slurry to facilitate said impacting.

7. The method of claim 6, further comprising generating ultrasonic cavitation within the abrasive slurry to facilitate said impacting.

8. The method of claim 1, wherein polishing a ceramic arc tube comprises polishing a material selected from the group consisting of single crystal ceramics, polycrystalline ceramics, and combinations thereof.

9. The method of claim 8, wherein the polycrystalline ceramics comprise one or more ceramics selected from the group consisting of Y₃Al₅O₁₂, Al₂O₃ and combinations thereof.

10. The method of claim 8, wherein the polycrystalline ceramics comprise one or more ceramics selected from the group consisting of Y₂O₃, AlON, Mg₂Al₂O₄, Lu₂O₃ and combinations thereof.

11. A method of polishing a ceramic arc tube comprising:
immersing the arc tube in a slurry comprising suspended abrasive particles; and
generating a turbulence within the slurry such that the abrasive particles are impacted against the inner surface and outer surface of the ceramic arc tube responsive to the turbulence.

12. The method of claim 11, wherein generating a turbulence within the slurry comprises generating ultrasonic cavitation within the slurry such that the abrasive particles are impacted against the inner surface and outer surface of the ceramic arc tube concurrently.

13. The method of claim 12, wherein the abrasive particles comprises diamond particles.

14. The method of claim 13, wherein the diamond particles range in size from about 0.1 μm to about 20 μm.

15. The method of claim 14, wherein the slurry further comprises a dispersant.

16. The method of claim 12, wherein the ceramic arc tube comprises a material selected from the group consisting of Y₃Al₅O₁₂, Al₂O₃, Y₂O₃, AlON, MgAl₂O₄, Lu₂O₃ and combinations thereof.

17. The method of claim 11, wherein the slurry further comprises magnetic particles suspended in the slurry.

18. The method of claim 17, wherein generating a turbulence within the slurry comprises magnetically inducing a rotational flow within the slurry such that the inner surface and outer surface of the ceramic arc tube are impacted by the abrasive particles concurrently.

19. The method of claim 18, wherein the abrasive particles comprises diamond particles.

20. The method of claim 19, wherein the diamond particles range in size from about 0.1 μm to about 20 μm.

21. The method of claim 19, wherein the slurry further comprises a dispersant.

22. The method of claim 21, wherein the slurry comprises a viscosity between about 0.5 and 5 centipoises.

23. The method of claim 18, wherein the magnetic particles suspended in the slurry comprise zinc iron ferrite.

24. The method of claim 23, wherein the ceramic arc tube comprises a material selected from the group consisting of Y₃Al₅O₁₂, Al₂O₃, Y₂O₃, AlON, MgAl₂O₄, Lu₂O₃ and combinations thereof.

25. The method of claim 11, wherein the ceramic arc tube comprises a material selected from the group consisting of Y₃Al₅O₁₂, Al₂O₃, Y₂O₃, AlON, MgAl₂O₄, Lu₂O₃ and combinations thereof.
